(19) United States
(12) Patent Application Publication
(10) Pub. No.: US 2003/0124990 A1
(43) Pub. Date: Jul. 3, 2003

(54) Vibrating linear actuator and portable information device having the same

(76) Inventors: Shinichiro Kawano, Osaka (JP); Noriyoshi Nishiyama, Osaka (JP); Kazuhiro Shimoda, Osaka (JP); Toshiyuki Iwahori, Yonago-shi (JP); Nobukazu Sugano, Takarazuka-shi (JP)

Correspondence Address: RATNERPRESTIA, P O BOX 980, VALLEY FORGE, PA, 19482-0980, US

(21) Appl. No.: 10/317,664

(22) Filed: Dec. 10, 2002

(30) Foreign Application Priority Data
Dec. 21, 2001 (JP) 2001-389137

(51) Int. Cl. H04B 1/38

(52) U.S. Cl. 455/90; 455/567

(57) ABSTRACT

A vibrating linear actuator includes a mover formed of an outer yoke having a heavy body, and a magnet. The actuator also includes a stator formed of an inner yoke having a coil and generating vibrating magnetic field to the outer yoke, and leaf springs, i.e., an elastic body, that couple the inner yoke to the outer yoke. The outer yoke is placed outside the inner yoke. This structure allows adjusting a magnitude of vibration of the actuator by simply changing a size of the outer yoke.

### TECHNICAL FIELD

The present invention relates to vibrating linear actuators and portable information devices in which the vibrating linear actuators are mounted.

### BACKGROUND ART

A vibrating paging-function is now essential to portable information devices such as cellular phones. The market requires vibration generators to be thinner because the portable information devices have become slimmer and slimmer.

FIG. 6 shows a sectional view of a conventional vibrating linear actuator. Japanese Patent Application Non-Examined Publication No. H08-65990 discloses vibrating linear actuator 100 as shown in FIG. 6. Actuator 100 includes mover 120 inside cylindrical stator 110.

In a conventional manner, greater vibration of a vibrating linear actuator requires a greater mass by enlarging a mover. In the case that the vibrating linear actuator is mounted in a portable information device, a width instead of a height of the mover is preferably widened in order to increase the mass of the mover because the portable device is desirably as thin as possible.

However, a wider mover requires a larger stator, so that the stator should be re-designed in accordance with a modification of the mover. A larger stator accompanies enlarging coil 140, so that a length of coil 140 is lengthened and a resistor value of coil 140 increases. As a result, the vibrating linear actuator consumes power more than necessary.

### DISCLOSURE OF INVENTION

The present invention addresses the problem discussed above, and aims to provide a vibrating linear actuator of which vibration is adjustable by simply changing a size of a mover. The vibrating linear actuator of the present invention comprises the following elements:

a mover including a magnet and a heavy body;

a coil;

a stator for generating a vibrating magnetic field to the mover; and

an elastic body for coupling the mover to the stator. The mover is positioned outside the stator.

This structure allows adjusting a magnitude of vibration by simply changing a size of the mover because the mover is placed outside the stator.

A portable information device of the present invention can be slimmed due to the advantage of the slim vibrating linear actuator of the present invention mounted therein.

### BRIEF DESCRIPTION OF THE DRAWINGS

FIG. 1 shows a sectional view of a vibrating linear actuator in accordance with a first exemplary embodiment of the present invention.

FIG. 2 shows a top view of the vibrating linear actuator shown in FIG. 1 with its cover removed.

FIG. 3A shows a bottom view of the vibrating linear actuator shown in FIG. 1.

FIG. 3B shows a perspective view of the vibrating linear actuator shown in FIG. 1.

FIG. 4A shows a top view of a board to which the vibrating linear actuator is mounted.

FIG. 4B shows a lateral view of the board in which the vibrating linear actuator is mounted.

FIG. 5 shows a portable information device (a cellular phone), in accordance with a second exemplary embodiment of the present invention, including the vibrating linear actuator in accordance with the first embodiment.

FIG. 6 shows a sectional view of a conventional vibrating linear actuator:

### PREFERRED EMBODIMENTS OF THE PRESENT INVENTION

Exemplary embodiments of the present invention are demonstrated hereinafter with reference to the accompanying drawings.

First Exemplary Embodiment

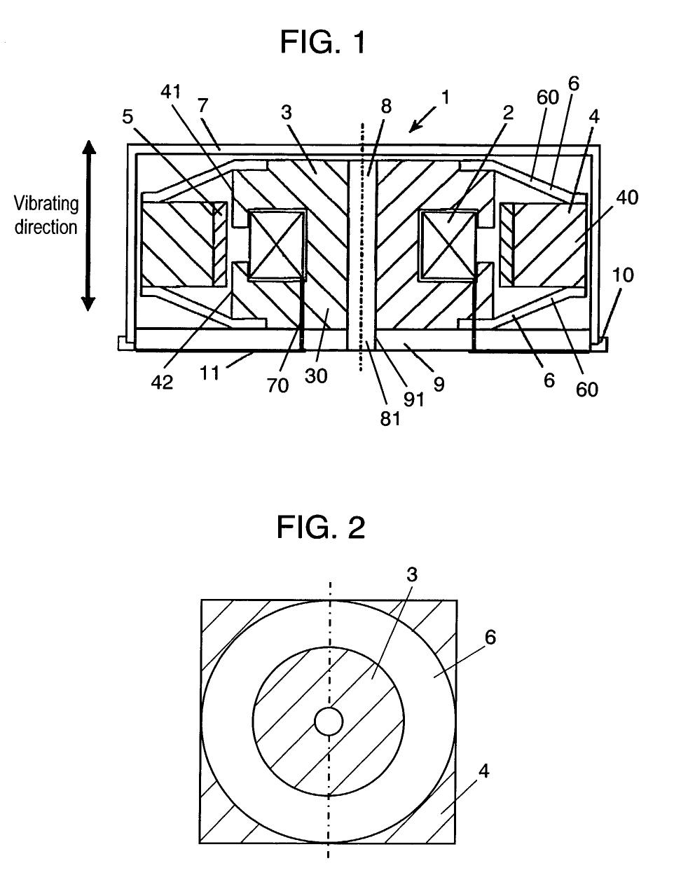

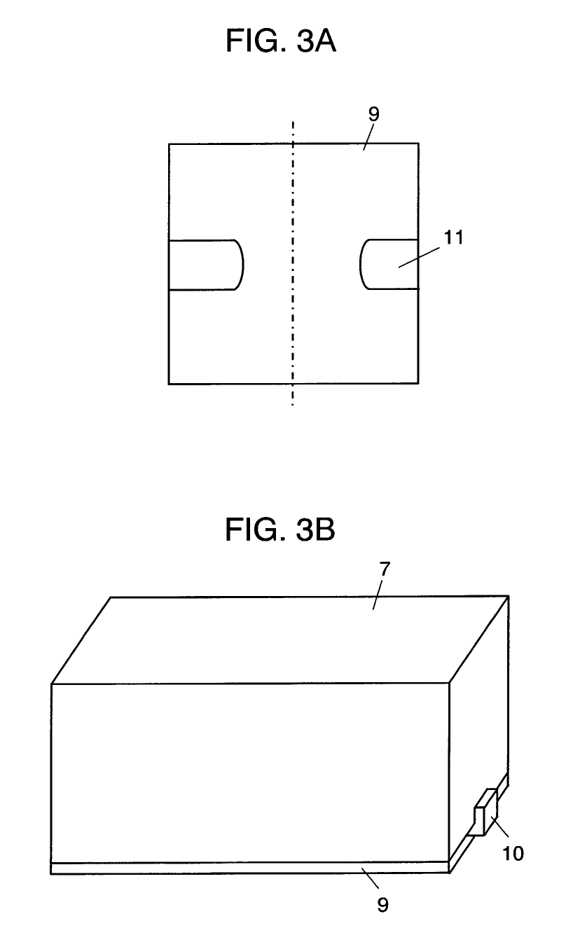

FIG. 1 shows a sectional view of a vibrating linear actuator in accordance with the first exemplary embodiment. FIG. 2 shows a top view of the same vibrating linear actuator with its cover removed. FIG. 3A shows a bottom view of the same vibrating linear actuator. FIG. 3B shows a perspective view of the sane vibrating linear actuator.

The structure of the vibrating linear actuator in accordance with the first embodiment is described using FIG. 1 through FIG. 3B. Vibrating linear actuator 1 comprises the following elements:

(a) polygonal outer yoke 4;

(b) inner yoke 3 disposed inside outer yoke 4;

(c) coil 2 wound on inner yoke 3; and

(d) magnet 5 rigidly provided to outer yoke 4 such that magnet 5 faces to inner yoke 3.

Magnet 5 is magnetized in different polarities at its inner wall and outer wall.

Outer yoke 4 is made of heavy body, and mover 40 in this actuator 1 is formed of magnet 5 and the heavy body (outer yoke 4). Inner yoke 3 is formed of an axially symmetric core of which sectional view shows like letter “H” (in FIG. 1, letter “H” rotates by 90 degrees). Stator 30 is formed of the core and coil 2 wound on a center portion of the core. Mover 40 is coupled to stator 30 with two elastic bodies 60 formed of e.g. upper and lower leaf springs 6, and mover 40 is placed outside stator 30.

The heavy body forming outer yoke 4 is detailed hereinafter. For instance, when the heavy body is a metallic body of which major ingredient is tungsten, it can increase a magnitude of the vibration. The heavy body can be another metallic body of which major ingredient is iron, or a compound metallic body of which major ingredients are iron and tungsten.

One of two elastic bodies 60 couples stator 30 to mover 40 at their upper faces, and the other one couples them at their lower faces

In this first embodiment, inner yoke 3 and outer yoke 4 are formed of metallic bodies; however, they can be formed of thin steel plates laminated radially (thin steel plates are laminated around shaft 8 radially).

In FIG. 1, the sectional view of inner yoke 3 shows like letter “H” rotated by 90 degrees. Shaft 8 is rigidly held by the center of inner yoke 3, and a first end of shaft 8 extends from the bottom of inner yoke 3 and is fixed to base 9; however it is not necessarily to extend through base 9. Inner yoke 3 is positioned with protruding portion 81 of shaft 8 and recess 91 of base 9, and fixed on base 9. Two leaf springs 6 link base 9 to inner yoke 3. Base 9 is made from heat-resistant resin of which glass transition temperature is not less than 90° C.

As shown in FIG. 2, each one of leaf springs 6 is formed of a ring-shaped leaf spring, and when outer yoke 4 (mover 40) moves downward from a balanced point, leaf spring 6 moves outer yoke 4 upward. When outer yoke 4 moves upward from the balanced position, leaf spring 6 moves outer yoke 4 downward.

Coil 2 is electrically coupled to metallic land 11 extending on the bottom of base 9, and powered from land 11. Land 11 can be prepared on a top face of cover 7 instead of the bottom of base 9.

Cover 7 covers inner yoke 3 and outer yoke 4, and is caulked to base 9 with cover-caulking section 10 prepared to base 9. Cover 7 protects the components inside of the actuator from touching other components outside the actuator or from damages when the actuator undergoes reflow-soldering. Cover 7 also helps handling of the actuator. Cover 7 is made from metal; however, it can be made from heat-resistant resin.

Actuator 1 flows the current supplied from land 11 to coil 2, thereby inner yoke 3 generates vibrating magnetic flux. This vibrating magnetic flux drives outer yoke 4. The mechanism of generating the vibration is detailed hereinafter.

Magnet 5 of mover 40 is cylindrical and the inner wall and the outer wall are, e.g., magnetized north pole (N) and south pole (S) respectively. In the status shown in FIG. 1, when coil 2 wound on inner yoke 3 is not powered, mover 40 stays still where energizing force of upper and lower leaf springs 6 balances with the weight of mover 40. Then electric current is supplied from land 11 to coil 2 in one direction, so that upper teeth 41 (first teeth 41) of inner yoke 3 are magnetized S pole and lower teeth 42 (second teeth 42) of inner yoke 3 are magnetized N pole. The N pole of inner wall of magnet 5 attracts the S pole of upper teeth 41, and the N pole of inner wall of magnet 5 repels the N pole of lower teeth 42, so that mover 40 moves upward. When mover 40 has moved to an upper place, the supply of the electric current is halted. At this status, force is applied to mover 40 to restore mover 40 to the initial stable place, i.e., the place between the upper teeth and lower teeth of inner yoke 3 because respective restoring forces of the upper and lower leaf springs balance each other. As a result, mover 40 is pushed back downward.

Next, electric current is supplied to coil 2 in the reverse direction, so that upper teeth 41 are magnetized N pole and lower teeth 42 are magnetized S pole. Then the N pole of inner wall of magnet 5 repels the N pole of upper teeth 41, and the N pole of inner wall of magnet 5 attracts the S pole of lower teeth 42, so that mover 40 moves downward. When mover 40 has moved to the lower place, the supply of the electric current is halted. At this status, force is applied to mover 40 to restore mover 40 to the initial stable place, i.e., the place between the upper teeth and lower teeth of inner yoke 3 because respective restoring forces of the upper and lower leaf springs balance each other. As a result, mover 40 is pushed back upward.

The operations discussed above are repeated at a given cycle, thereby vibrating mover 40. Those operations are just one instance, and there are various ways to power the coil.

FIG. 3A shows a base bottom of the vibrating linear actuator. Two lands 11 are exposed from the bottom of base 9. FIG. 3B shows a perspective view of the actuator, and illustrates an external appearance of the actuator. Cover 7 is rigidly caulked to base 9 by caulking portion 10 prepared to base 9.

As shown in FIG. 1, path 70 through which a line for supplying current to coil 2 runs is provided to parts of the core forming inner yoke 3, so that the coil can be led out with ease. Path 70 is a communicating hole or a communicating groove between the inside and the outside of the core. The hole or the groove is formed by pulling out parts of the core.

Magnet 5 of actuator 1 is shaped like a ring; however, it can be divided into four or six pieces in a circular direction. The magnetic field produced by those magnet-pieces can be treated as pseudo-radial-oriented magnetic field.

The inside of the heavy body is preferably shaped like a circle, and the outside is preferably shaped like a polygon, because a quadrangular shape is suitable to surface-mounting onto a circuit board, and the heavy body in a quadrangular shape can increase its weight.

In actuator 1, outer yoke 4 is included in mover 40, therefore, vibration amount of vibration actuator 1 can be determined proportional to the mass of outer yoke 4. In this first embodiment, outer yoke 4 can be enlarged by extending itself outward without modifying the structure of inner yoke 3 or coil 2. Thus the magnitude of the vibration can be changed by simply changing the mass of outer yoke 4. Increasing the mass of outer yoke 4 does not require a change of the coil length, so that a power loss due to the coil resistor becomes less than that of the conventional actuator.

As discussed above, the vibrating linear actuator of the present invention can be adjusted in magnitude of vibration with ease, and a shorter length of the coil than that of the conventional actuator can work well enough, so that a less power consumption can be expected.

Second Exemplary Embodiment

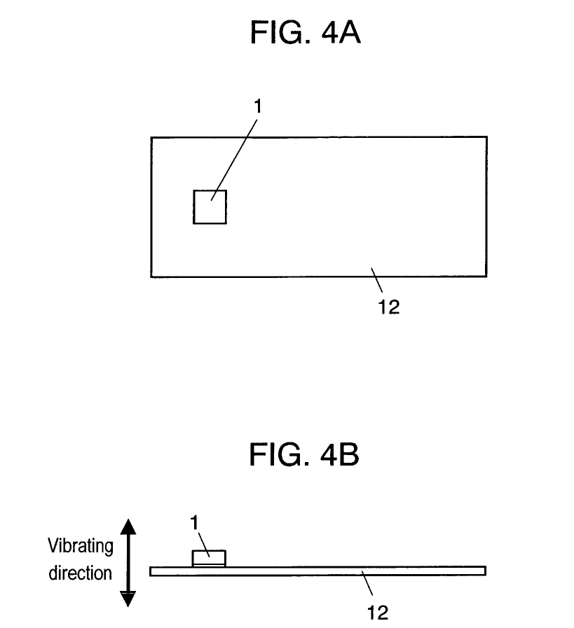

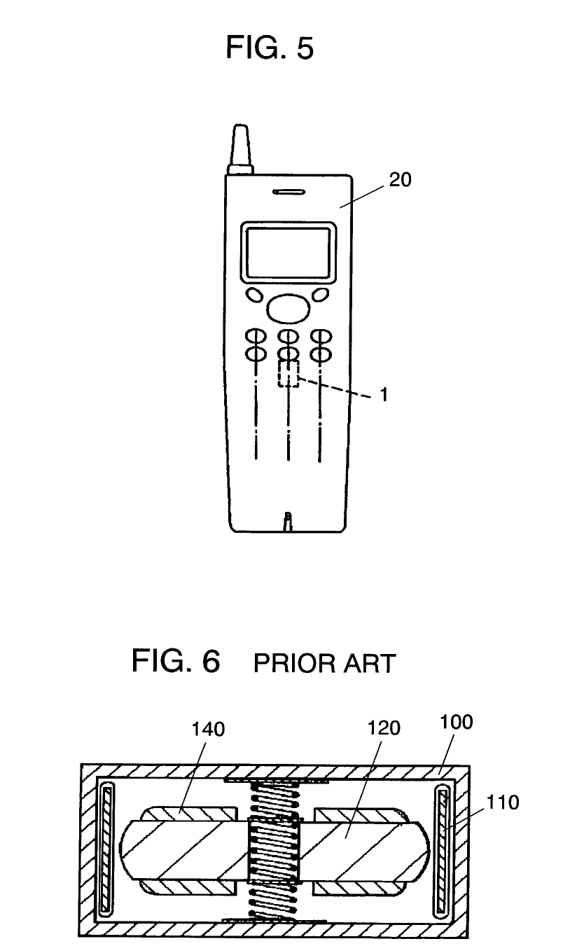

FIG. 4A shows a top view of a board to which the vibrating linear actuator shown in FIG. 1 is mounted. FIG. 4B shows a lateral view of the same board. FIG. 5 shows a portable information device (a cellular phone) including the vibrating linear actuator shown in FIG. 1.

As shown in FIG. 5, vibrating linear actuator 1 is mounted in cellular phone 20. FIG. 4A and FIG. 4B illustrate actuator 1 mounted on board 12 of the cellular phone shown in FIG. 5. Board 12 is a double-sided and multi-layered board, and other components (not shown) are also mounted thereto.

An advantage of the portable information device (cellular phone) in accordance with the second embodiment is the mounting of the vibrating linear actuator in accordance with the first embodiment in the portable information device. Therefore, the portable information device (cellular phone) in accordance with the second embodiment is adjustable its magnitude of vibration with ease, and it can be slimmer, consumes less power than portable information devices that employ conventional actuators.

What is claimed is:

1. A vibrating linear actuator comprising:
(a) a mover including a magnet and a heavy body;
(b) a stator including a coil and generating vibrating magnetic field to said mover;
(c) an elastic body for coupling said stator to said mover, wherein said mover is disposed outside said stator.

2. The vibrating linear actuator of claim 1, wherein said stator includes an axially symmetric core of which sectional view shows like letter “H” and a coil wound on a center portion of the core.

3. The vibrating linear actuator of claim 1, wherein the heavy body is one of a metallic body including tungsten as a major ingredient, a metallic body including iron as a major ingredient, and a compound metallic body including iron and tungsten as major ingredients.

4. The vibrating linear actuator of claim 1, wherein said elastic body includes two pieces, and each one of the pieces couples said stator to said mover at both end-faces of said stator and said mover.

5. The vibrating linear actuator of claim 4, wherein said elastic body is a leaf spring.

6. The vibrating linear actuator of claim 2, wherein a path is provided to a part of the core, and a line for supplying electric current to the coil runs through the path.

7. The vibrating linear actuator of claim 1, wherein the magnet is shaped like a ring.

8. The vibrating linear actuator of claim 1, wherein the magnet is divided into one of four, five and six pieces in a circular direction.

9. The vibrating linear actuator of claim 1, wherein an inside of the heavy body is shaped like a circle, and an outside thereof is polygonal.

10. The vibrating linear actuator of claim 2, wherein the heavy body is included in an outer yoke, and the core is included in an inner yoke.

11. A portable information device comprising:
a board;
a vibrating linear actuator mounted to said board;
wherein said vibrating linear actuator including:
a mover including a magnet and a heavy body;
a stator including a coil and generating vibrating magnetic field to said mover;
an elastic body for coupling said stator to said mover, wherein said mover is disposed outside said stator.

12. The portable information device of claim 11, wherein said stator includes an axially symmetric core of which sectional view shows like letter “H” and a coil wound on a center portion of the core.

13. The portable information device of claim 11, wherein the heavy body is one of a metallic body including tungsten as a major ingredient, a metallic body including iron as a major ingredient, and a compound metallic body including iron and tungsten as major ingredients.

14. The portable information device of claim 11, wherein said elastic body includes two pieces, and each one of the pieces couples said stator to said mover at both end-faces of said stator and said mover.

15. The portable information device of claim 14, wherein said elastic body is a leaf spring.

16. The portable information device of claim 12, wherein a path is provided to a part of the core, and a line for supplying electric current to the coil runs through the path.

17. The portable information device of claim 11, wherein the magnet is shaped like a ring.

18. The portable information device of claim 11, wherein the magnet is divided into one of four, five and six pieces in a circular direction.

19. The portable information device of claim 11, wherein an inside of the heavy body is shaped like a circle, and an outside thereof is polygonal.

20. The portable information device of claim 12, wherein the heavy body is included in an outer yoke, and the core is included in an inner yoke.
